(19) United States
(12) Patent Application Publication
(10) Pub. No.: US 2013/0198750 A1
(43) Pub. Date: Aug. 1, 2013

(54) WIZARD-BASED SYSTEM FOR BUSINESS PROCESS SPECIFICATION

(71) Applicants: Yasmine Charif, Rochester, NY (US); Andres Quiroz Hernandez, Rochester, NY (US)

(72) Inventors: Yasmine Charif, Rochester, NY (US); Andres Quiroz Hernandez, Rochester, NY (US)

(73) Assignee: XEROX CORPORATION, NORWALK, CT (US)

(21) Appl. No.: 13/360,829

(22) Filed: Jan. 30, 2012

(51) Int. Cl. G06F 9/46

(52) U.S. Cl. 718/102

(57) ABSTRACT

Method and systems assist non-programmer users in specifying business processes. Users submit high-level descriptions of simple, incomplete, or incorrect business processes in softcopy form illustrating the orchestration of services (or the control flow), and get prompted with suggestions to specify the services' data flow. The method and systems herein assist in specifying data flowing between services, but also detects missing edges and services, for which the method and systems herein also provide data flow suggestions. The suggestions are computed and ranked using heuristics, and displayed through a wizard to the user.

### BACKGROUND

Embodiments herein generally relate to workflow systems and methods and more particularly to systems and methods that provide suggestions of changes to formalize existing workflows where the suggestions are computed and ranked using heuristics, and displayed through a wizard to the user.

Business process management systems allow users to specify compositions of inter-organizational services that can be translated into an executable format (e.g., workflows, etc.). This specification requires the user, for example, to have an accurate description of the business process to design, and to know each of the service implementations' specification. The user is thus required to manually select each such service implementation required in the business process, and bind the service operation parameters with the business process and other services operations parameters. Therefore, existing workflow and planning systems are meant for users with not only business analyst knowledge, but also with strong programmer/service provider skills. Additionally, by supporting business specification at the concrete (programmatic) level, these systems lack the flexibility of multiple concrete options and workflow reuse.

### SUMMARY

The method and systems herein assist non-programmer users in specifying business processes. Users submit high-level descriptions of simple, incomplete, or incorrect business processes in softcopy form illustrating the orchestration of services (or the control flow), and get prompted with suggestions to specify the services' data flow. The method and systems herein assist in specifying data flowing between services, but also detect missing edges and services, for which the method and systems herein also provide data flow suggestions. The suggestions are computed and ranked using heuristics, and displayed through a wizard to the user. The output of the system is a completed and corrected business process, readily instantiable, if the user was able to validate at least one of the wizard suggestions at each step of the specification, or a description of the missing service requirements otherwise. The resulting business process can be, for example, described in the well-known BPMN 2.0 standard in order to be executed by existing business process engines.

Therefore, for example, one exemplary computer-implemented method herein receives an initial document processing workflow into a computerized device from a user. The initial document processing workflow has an overall logical goal to transform at least one input into at least one output. This exemplary method identifies process flow informalities within the initial document processing workflow based at least in part on relative positions of flow shapes within the initial workflow, data types of the flow shapes, and use of the flow shapes in previous workflows. For example, the process flow informalities can include missing logical processes, missing connections between logical processes, vague words, syntactic irregularities, and/or illogical process elements, etc.

This method then produces solution flow suggestions as alternatives to the process flow informalities and/or additions to the initial document processing workflow, using the computerized device. For example, this method can automatically identify inputs and outputs of services within the initial workflow and match the inputs and outputs.

This exemplary method can also rank the solution flow suggestions using the computerized device. The ranking gives a higher ranking to solution flow suggestions that are more closely aligned with the overall logical goal (relative to other solution flow suggestions) to produce a ranked order for the solution flow suggestions. Then this method can display the initial document processing workflow, the process flow informalities, and the solution flow suggestions in the ranked order to the user on a graphic user interface device (that is operatively connected to the computerized device).

In response to the process flow informalities and the solution flow suggestions, this method can receive document processing workflow modifications from the user through the graphic user interface device. Then, this exemplary method can substitute some of the solution flow suggestions for the process flow informalities in the initial document processing workflow and/or add some of the solution flow suggestions to the initial document processing workflow to produce a modified document processing workflow (again, using the computerized device). This method then outputs the modified document processing workflow from the computerized device.

A computerized document processing system embodiment herein includes a computerized device receiving the initial document processing workflow. The computerized device identifies the process flow informalities within the initial document processing workflow, and the computerized device produces the solution flow suggestions as alternatives to the process flow informalities. Further a graphic user interface device is operatively connected to the computerized device. The graphic user interface device displays the initial document processing workflow, the process flow informalities, and the solution flow suggestions. The graphic user interface device then receives workflow modifications in response to the process flow informalities and the solution flow suggestions. The computerized device can substitute the solution flow suggestions for the process flow informalities in the initial workflow to produce the modified document processing workflow using the computerized device. A document processing device is also operatively connected to the computerized device. The document processing device can execute the modified document processing workflow.

These and other features are described in, or are apparent from, the following detailed description.

### BRIEF DESCRIPTION OF THE DRAWINGS

Various exemplary embodiments of the systems and methods are described in detail below, with reference to the attached drawing figures, in which:

FIG. 1 is a schematic block diagram illustrating various processing according to systems and method herein;

FIG. 2 is a schematic block diagram illustrating various processing according to systems and method herein;

FIG. 3 is a schematic block diagram illustrating various processing according to systems and method herein;

FIG. 4 is a screenshot illustrating various processing according to systems and method herein;

FIG. 5 is a screenshot illustrating various processing according to systems and method herein;

FIG. 6 is a schematic block diagram illustrating various processing according to systems and method herein;

FIG. 7 is a schematic block diagram illustrating a hierarchical structure according to systems and method herein;

FIG. 8 is a schematic block diagram illustrating various processing according to systems and method herein;

FIG. 9 is a schematic block diagram illustrating various processing according to systems and method herein;

FIG. 10 is a schematic block diagram illustrating various processing according to systems and method herein;

FIG. 11 is a schematic block diagram illustrating various processing according to systems and method herein;

FIG. 12 is a schematic block diagram illustrating various processing according to systems and method herein;

FIG. 13 is a schematic block diagram illustrating various processing according to systems and method herein;

FIG. 14 is a schematic block diagram illustrating various processing according to systems and method herein;

FIG. 15 is a schematic block diagram illustrating various processing according to systems and method herein;

FIG. 16 is a schematic block diagram illustrating various processing according to systems and method herein;

FIG. 17 is a schematic block diagram illustrating various processing according to systems and method herein;

FIG. 18 is a schematic block diagram illustrating various processing according to systems and method herein;

FIG. 19 is a schematic block diagram illustrating various processing according to systems and method herein;

FIG. 20 is a schematic block diagram illustrating various processing according to systems and method herein;

FIG. 21 is a schematic block diagram illustrating various processing according to systems and method herein;

FIG. 22 is a schematic block diagram illustrating various processing according to systems and method herein;

FIG. 23 is a screenshot illustrating various processing according to systems and method herein;

FIG. 24 is a flow diagram illustrating various processing according to systems and method herein;

FIG. 25 is a schematic block diagram illustrating various systems herein; and

FIG. 26 is a schematic block diagram illustrating various systems herein.

### DETAILED DESCRIPTION

In this disclosure, specification of business process workflows, are sometimes referred to simply as “workflows”. As used herein, concrete services are sometimes referred to as executable services. In addition, this disclosure interchangeably uses the term abstract service, as a service type to refer to a service description that can have multiple concrete service implementations.

Business Process Management Systems (BPMS) are a useful part of modern businesses as they attempt to streamline and automate, as much as possible, the complex workflows and interactions between human and software systems. BPM encompasses a wide range of activities, from abstracting processes or process requirements into service and workflow definitions, to translating those abstract definitions into formal process descriptions, to eventually concretizing and executing those processes within a framework that supports their orchestration. BPMN (Business Process Modeling Notation) [BPMN2.0] has been developed by OMG (Object Management Group) [OMG] Needham, Mass., USA, as a standard notation to describe abstract and executable Business Processes.

Business process management systems are meant to assist some or all of the participants of the business process management life cycle, so that process abstraction, design, definition, deployment and/or execution can be accomplished as efficiently as possible. However, translating system artifacts from one stage of the life cycle to the next requires much of the analyst, which may be impractical. For example, the analyst needs to have programming skills in order to connect one service operation to the other and specify the data flow, and must provide attention on the workflow specification at the programmatic level, which can take away from the attention on the functional design. Further, the analyst should maintain sufficient knowledge about specific services from a possibly large inter-organizational pool in order to be able to select the most appropriate service for a desired task, and the most appropriate combination of specific services to enact the business process, including the possible compatibility, i.e. connectivity restrictions between them.

Additionally, some systems support the workflow design at the concrete level (orchestrating concrete services, as opposed to service types) so that the ability to reuse previously defined workflows is hampered, and a single concrete workflow will be produced by the analyst instead of multiple options which are enabled by concretizing an abstract workflow.

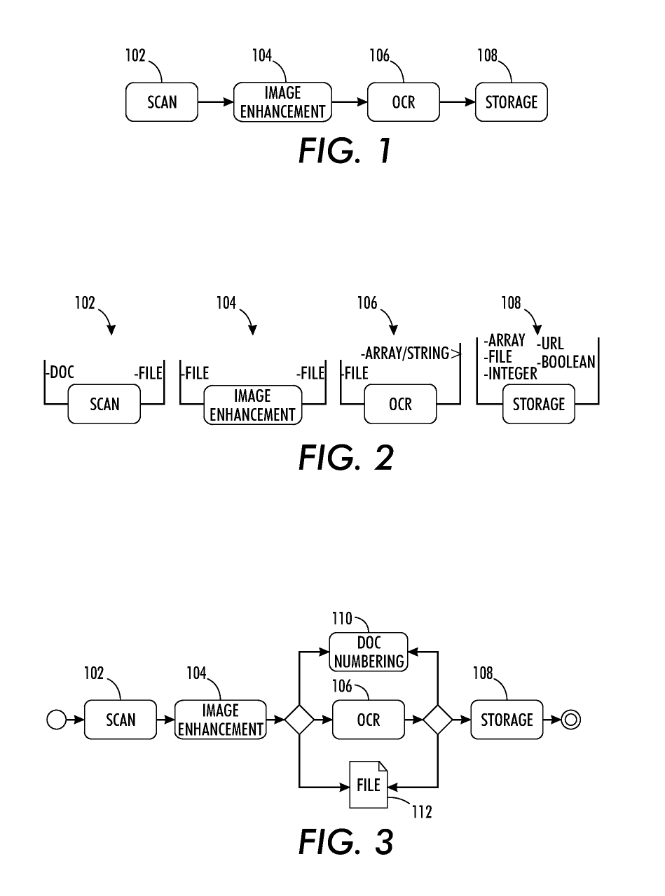

The systems and methods herein provide non-programmer users with an assistive system to specify business processes. The user submits a softcopy workflow depicting high-level descriptions of simple, incomplete, or incorrect business processes. FIG. 1 depicts an example of a user requirement for a document processing workflow that may be supplied by the user in softcopy form. Those ordinarily skilled in the art would understand that this is merely a simplified example used to illustrate aspects of the various methods and system herein, and that the embodiments herein are not limited to this example, but instead are equally applicable to any and all workflows and workflow systems (whether currently known or developed in the future). As shown in FIG. 1, this user-supplied workflow includes workflow blocks for scanning a form 102, enhancing the image quality of the produced file 104, extracting specific fields (such as optical character recognition (OCR)), and storing the OCR fields together with the file 108. In the following drawings, this example will be used to illustrate the different aspects of the systems and methods herein.

The systems and methods herein then prompt the user with suggestions to specify the services' data flow and detect missing edges and services, for which the systems and methods herein also provide data flow suggestions. These suggestions are based on the analysis of the input/output data types given in the service type specification that service providers supplied while registering their services in a service type repository. More specifically, FIG. 2 illustrates the service types specified by service providers. Thus, for example, the systems and methods herein calculate that the scan service 102 uses a document as input and produces a file as output. Similarly, the systems and methods herein automatically calculate that the image enhancement service 104 uses an input file and produces an output file. In a similar way, the systems and methods herein automatically calculate that the OCR service 106 uses an input file and outputs an array string. Thus, the systems and methods herein further automatically calculate that the storage service 108 inputs an array string, a file, and an integer, and outputs a uniform resource locator (URL) and a Boolean string.

Thus, from the initial workflow, such as shown in FIG. 1, the systems and methods herein produce a business process (for example, in BPMN 2.0 format) such as that shown in FIG. 3. This business process is in turn automatically completed and corrected by the systems and methods herein in the following ways. As shown in FIG. 3, inputs/outputs are connected into a data flow. Further, the systems and methods herein calculate (based on the relative positions of the flowchart blocks and arrow connections) that the file produced by the scanning service 102 is supplied to the image enhancement service 104. Again, from the relative positions of the flowchart blocks and their relative inputs/outputs, the systems and methods herein automatically calculate that the file 112 required by the Storage service 108 is carried over from the Image Enhancement Service 104 (even though it is not available from the preceding OCR Service). This file 112 is automatically added to the workflow by the systems and methods herein as shown in FIG. 3.

In addition, to complete a predetermined logical requirement, a document numbering service 110 is added as an edge service. An “edge service” is a service that does not initially belong to the workflow but acts as an edge to connect an input/output pair. In the example, the document numbering service 110 connects a missing input (the integer parameter) for the storage service 108 to an existing output (file 112) of the image enhancement service 104.

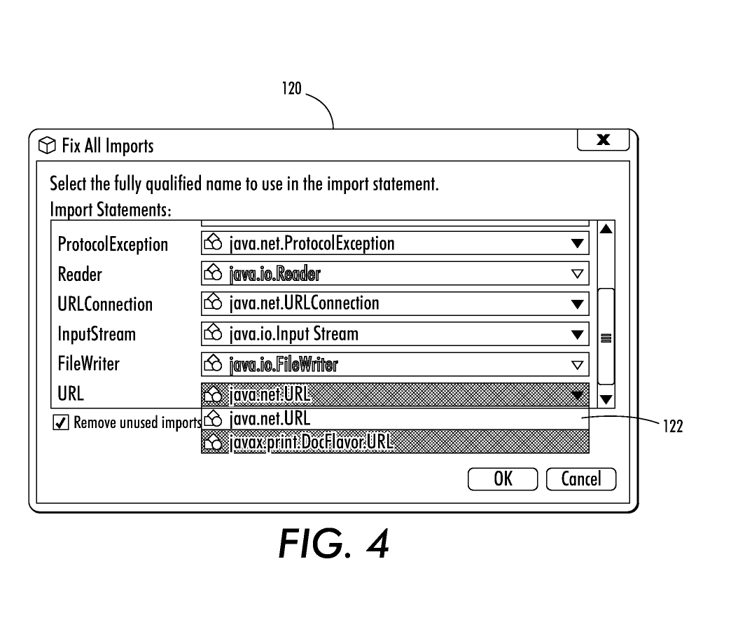

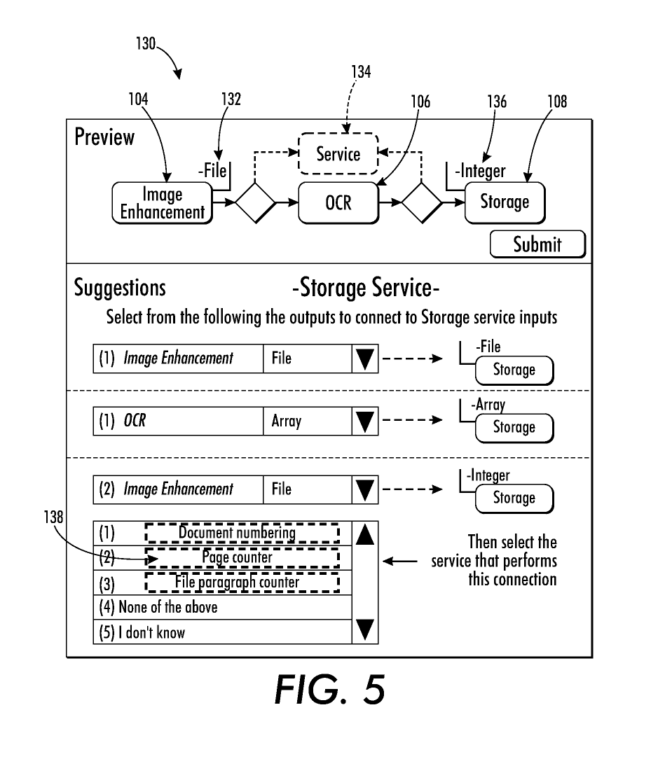

In order to obtain such a result, the user is driven through a step-by-step specification approach by means of a wizard, a screen shot of which is shown in FIG. 5, discussed below. As shown in the screen shot 120 in FIG. 4, a system can provide options 122 for each class, given as a list of suggestions. However, these suggestions shown in FIG. 4, as well as function call parameters are computed in a predetermined order without sufficient consideration of contextual information.

On the contrary, the systems and methods herein go beyond data type information to suggest, by means of the wizard, the most likely options first. This is done by using a series of heuristics based on data type compatibility, data type transformations, and historical data.

As illustrated by FIG. 5, the wizard herein displays and ranks options for service binding. Therefore, the user can choose from among the suggestions the appropriate data flow, i.e., binding between a service input 134 and another service output 134, in an assisted and ergonomic manner. For instance, the wizard screenshot 130 shown in FIG. 5 pops up with at least a partial workflow (having items 104, 106, 108, discussed above) to suggest the most likely bindings for each of the inputs of the storage service 108. Two of the inputs (file 132 and array) can be bound with compatible outputs of previous services (image enhancement service 104 and OCR service 106). However, the methods and systems herein automatically identify that the third input (integer 136) is a logical missing input and this prompts the methods and systems herein to present a series of service choices 138 that can perform the transformation from an available service output (what will eventually become the file 112 from the image enhancement service 104, shown in FIG. 3).

Therefore, with the embodiments herein, at each step of the business process specification, the user selects one of the wizard suggestions, and the system produces a complete and corrected business process as shown in FIG. 3. If, on the contrary, the user is not sure about the appropriate choice, the system provides the user with suggestions that the system gathered from the list of possible inputs and outputs that could be bound, as well as service descriptions that can be used for this binding.

Thus, as shown in greater detail below, the wizard interface ranks the possible options in the suggestions based on heuristic rules such that the most likely options for binding are more readily accessible to the user. This removes the requirement on the user to have programmer skills Further, the service registration interface described below allows service providers to register and describe their services, mapping them to a generic service type in a repository of abstract services, and thus setting up an implicit agreement on service semantics and use. This removes the requirement on user to have knowledge about inter-organizational services. The support of business process specification at the abstract level herein ties into a framework that finds the optimal concrete service combinations for the abstract service workflow, and stores and indexes existing workflows and service compositions. This gives multiple functionally equivalent concrete business process options to the user, keeps the attention of the user on the business process functional design rather than the implementation, facilitates business process reuse, and results in better suggestions from the use of heuristics and historical data.

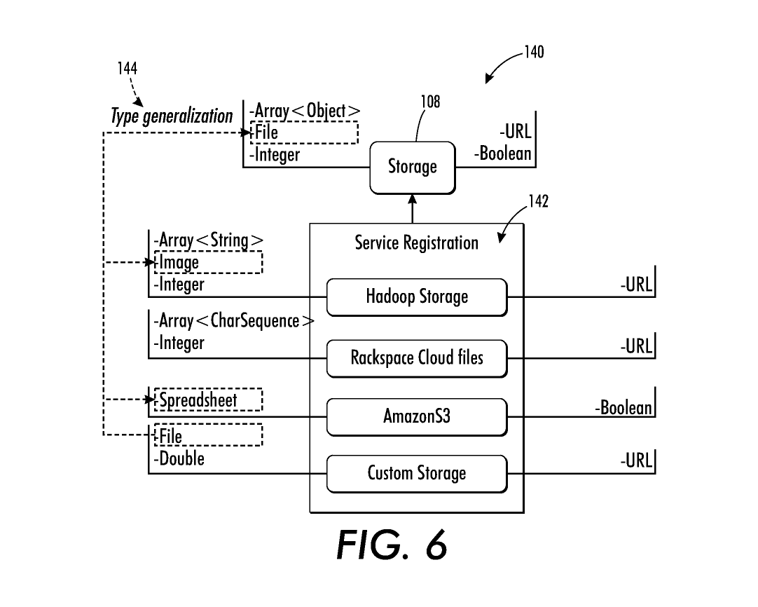

The service registration aspect herein supports service interoperability and sets up a common agreement on services semantics and use. For example, the service registration can be performed through an interface (a screen shot 140 of which is shown in FIG. 6) where service providers store and map their (concrete) services 142 to generic service types (such as storage service 108) in a repository of abstract services, and map their operation parameters to generic data types.

This mapping between a concrete service operation and a service type includes a mapping of the operation name to the abstract service name 142 (e.g., Hadoop Storage store_operation is registered as a Storage service type), a mapping of each input/output type of the operation to the most specific compatible parameter (both semantically and by data type) that is available with the input/output type of the abstract service (e.g., spreadsheet and image are mapped to file 144). The input/output data types of each service type may be updated with each new registered service when the concrete parameter type (e.g., File) is a super-type of the abstract service (e.g., Image). Further, no existing input/output data types of the abstract service are sub-types or super-types of the concrete operation type. A complete service registration mechanism is specified separately of this systems and methods herein.

Business processes and service compositions can be stored within a glue code repository. A glue code repository reuses well-defined workflows and retrieves previous bindings between services as hints for new service bindings (used in the ranking heuristics) thus allowing the system to produce a more informed ranking of binding options.

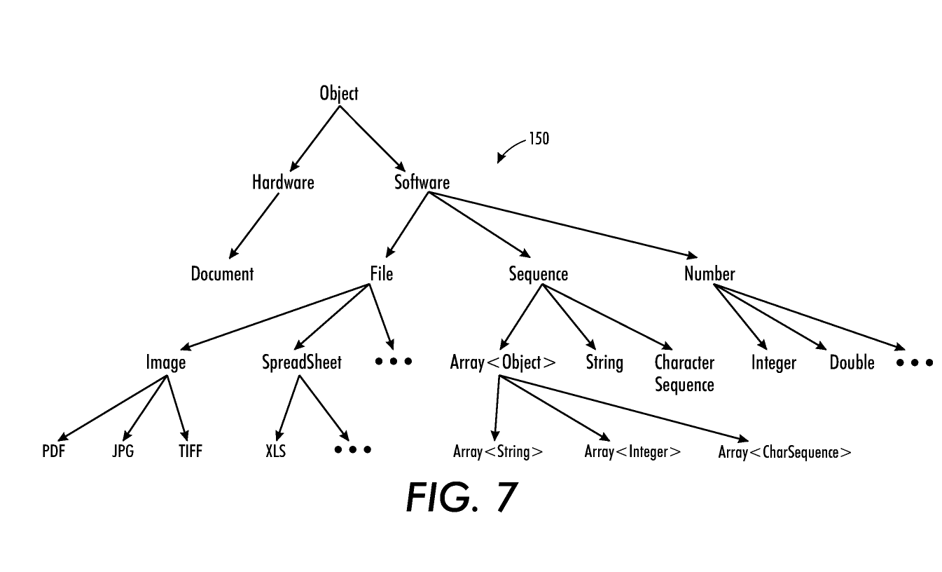

In order to perform input/output mapping in the service registration as well as service binding, the systems and methods herein assess the compatibility between different data types. For this purpose, the systems and methods herein make use of a predefined hierarchy of data types, such as the exemplary hierarchy 150 illustrated in FIG. 7. For example, the systems and methods herein can consider data types to be compatible if they are on the same path of the hierarchy originating from the root.

Each abstract service may have a transformation function defined by associating the “main” input with the “main” output of the operation (e.g., in image enhancement service 104, the operation enhance_image_quality transforms the input file to the output file). An input/output data type is considered “main” to an operation if the function/purpose of the operation is affected the most by removing/changing the input/output. The transformation function applies by default to inputs and outputs, which have compatible data types, and have a small semantic distance. The service provider may then override the transformation function by linking the inputs and outputs involved in a transformation during service registration.

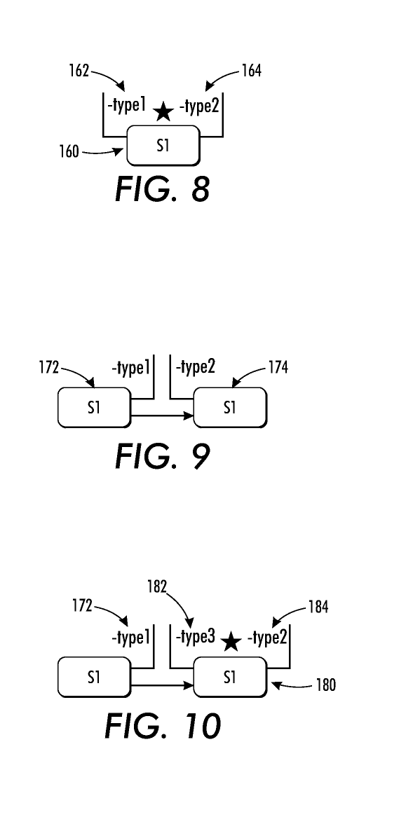

FIG. 8 depicts a service 160 defining a transformation (represented by a star in this document) between type1 (162) and type2 (164). Type1 is referred to as the left hand side (LHS) of the transformation, and type2 as the right hand side (RHS). Therefore, as shown in FIGS. 8-10, a data type1 162 is linked to a data type2 164 in a workflow if: they are the LHS 162 and RHS 164 of a transformation function 160 (FIG. 8); if they have been connected by the user in the data flow 172, 174 (FIG. 9); or if there is a data type3 182, so that type1 172 is linked to type3 182, and type3 182 is linked to type2 184 in service 180 (FIG. 10).

The systems and methods herein assist a user to obtain the data flow (input/output mapping) from a given abstract workflow. The systems and methods herein use a series of heuristics based on data type compatibility, data type transformations, and historical data to classify and order the binding options. The reason for adopting this approach is twofold. First, data type compatibility is not enough because using data type compatibility alone leads to often inaccurate suggestions in auto complete features of IDEs. In the running example of this disclosure, several data type compatibilities can be observed, e.g., file types for scan, image enhancement, and storage services, yet these features are not sufficient to assess the most appropriate bindings. Secondly, data semantics in the context of a workflow may be irrelevant. Indeed, it is the purpose of the service composition, and not of the independent services, that determines the relation of the parameter names that should be matched together, e.g., enhancedImage and storedFile may be names of image enhancement and storage services parameters that may be matched in a composition, even though the names do not have any semantic relation between them.

In order to complement data type compatibility, the heuristics are based on general principles. One principle is that workflows are often designed as an end-to-end transformation of data objects. Thus, identifying the transformations that each service performs on a data object as it moves through the workflow gives an indication of the parameters that should be bound together. Another principle is that users will likely apply the same combinations of services in different workflows so that keeping track of the ways the services are bound in the past will be useful to guide future compositions.

With respect to heuristics for ranking suggestions, the systems and methods herein keep a list of all workflow inputs, i.e. external data objects made available by the user at the start of a workflow, and a list of intermediate outputs, i.e. for a service, these are outputs from all services preceding or parallel to it in the workflow. These data objects (represented by their corresponding data types) constitute the available outputs, and are referred to as a wavefront for that particular service. A wavefront is a wave of outputs that originates with the workflow inputs and grows as more outputs become available for each service.

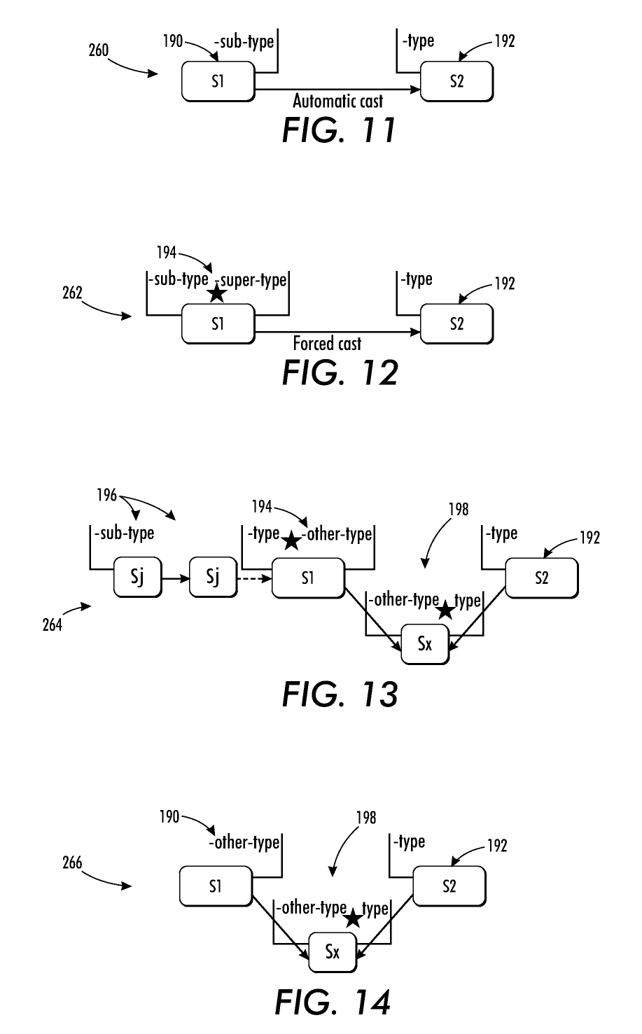

For each service (S in the Figures) input, the systems and methods herein classify and rank the available outputs in the order that they are most likely to be connected to it in a data flow, and present them to the user accordingly. The initial classification of wavefront outputs is as shown in FIGS. 11-14. More specifically, as shown in FIG. 11, the wavefront outputs, e.g., from S1 (190), that are sub-types of the input data type from S2 (192). The sub-type and super-type relationships are assessed by paths in the hierarchy. As shown in FIG. 12, the wavefront outputs, e.g., from S1 (194), are super-types of the input data type from S2 (192), but can be linked to a sub-type input or output (262), e.g., input transformed by S1. Next, as shown in FIG. 13, the wavefront outputs, e.g., from S1 (194), are not compatible (neither sub- nor super-type) with the input data type from S2, but can be linked to an output of type 260 and 262 (196), e.g., input to S1. This binding typically requires the insertion of an edge service, e.g., Sx (198), to perform the transformation between S1-output (194) and S2-input (192). As show in FIG. 14, the wavefront outputs, e.g., from S1 (190), that are not compatible (neither sub- nor super-type) with the input data type of S2 (192), are the LHS of a possible transformation to that type can be transformed using Sx (198).

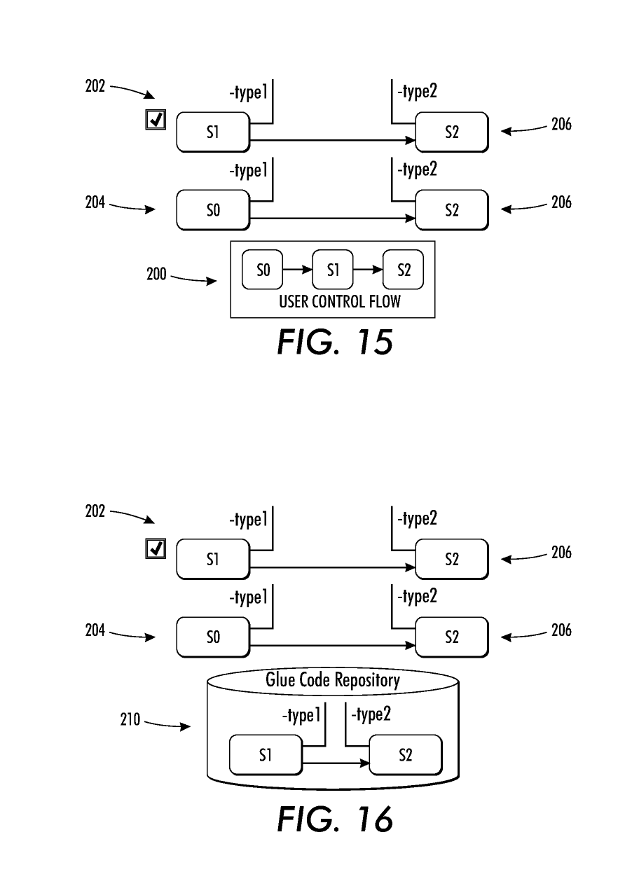

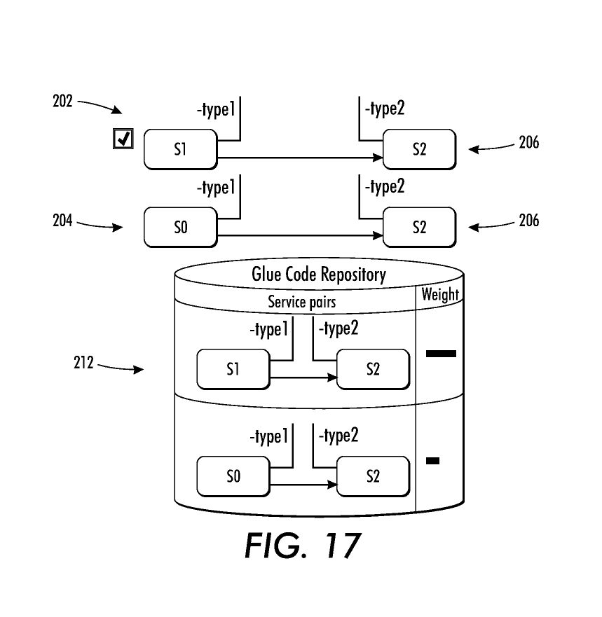

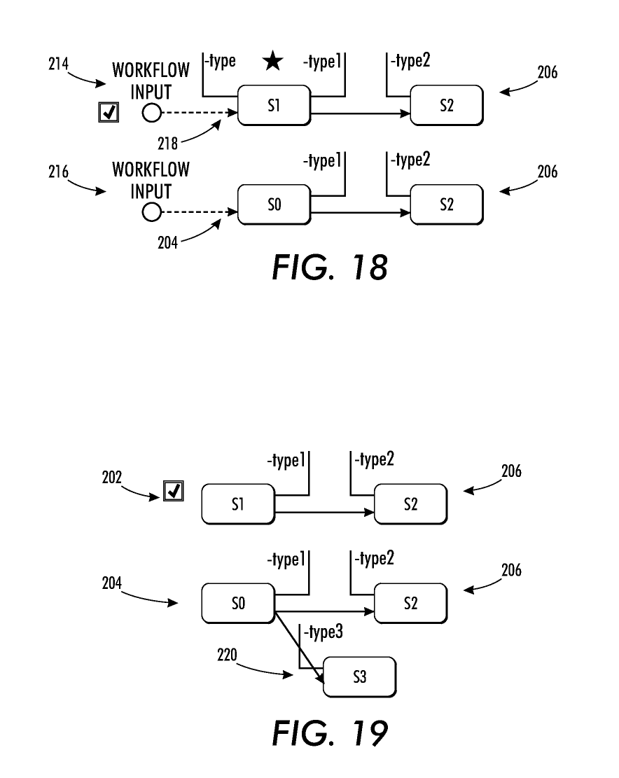

As shown in FIGS. 15-19, the classification produces groups of outputs in the wavefront. Within each ranking group, for an unconnected service S2 input type2 (206), outputs (202, 204) are ranked higher according to the following heuristics. As shown in FIG. 15, output 202 is ranked higher if the output, e.g., type1, belongs to a service S1 (202) directly or more closely preceding the unconnected service 206 in the user workflow 200. As shown in FIG. 16, output 202 is ranked higher if the output, e.g., type1, is produced by a service S1 (202) such that S1 and S2 are bound by the same input/output pair (type1 and type2) in the glue code repository 210. As shown in FIG. 17, if two outputs in the wavefront, e.g., type1 from S0 (204) and S1 (202), are bound by the same input/output pair, they are ranked according to the weight of the corresponding service pairs in the glue code repository 212, i.e. number of occurrences out of the total number of stored workflows. As shown in FIG. 18, output 218 is ranked higher if the output, e.g., type1 from S1, is linked to a workflow/user input. As shown in FIG. 19, output 202 is ranked higher if the output, e.g., type1 from S1, is not already bound to an input (as opposed to S1 (204) which is already bound to input S3 (220).

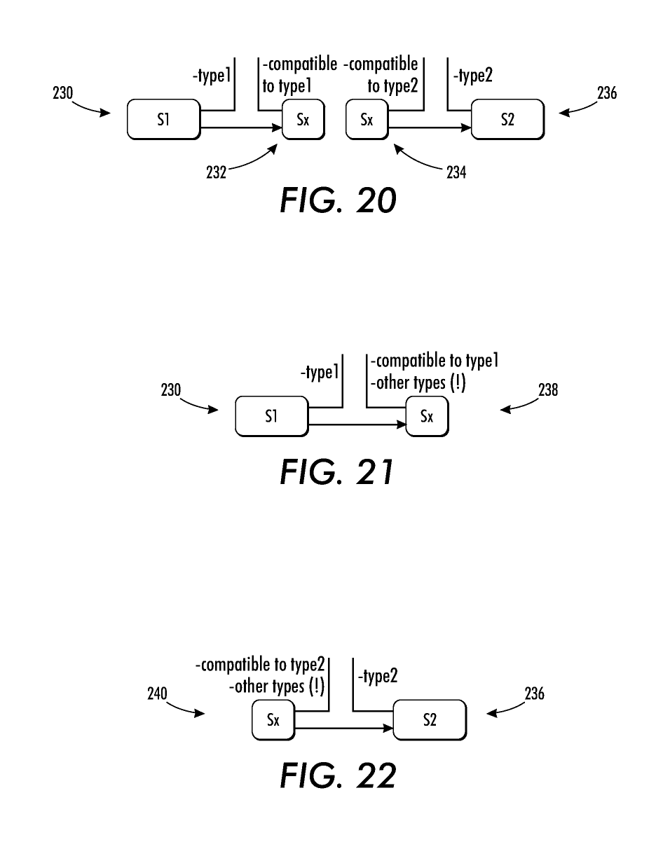

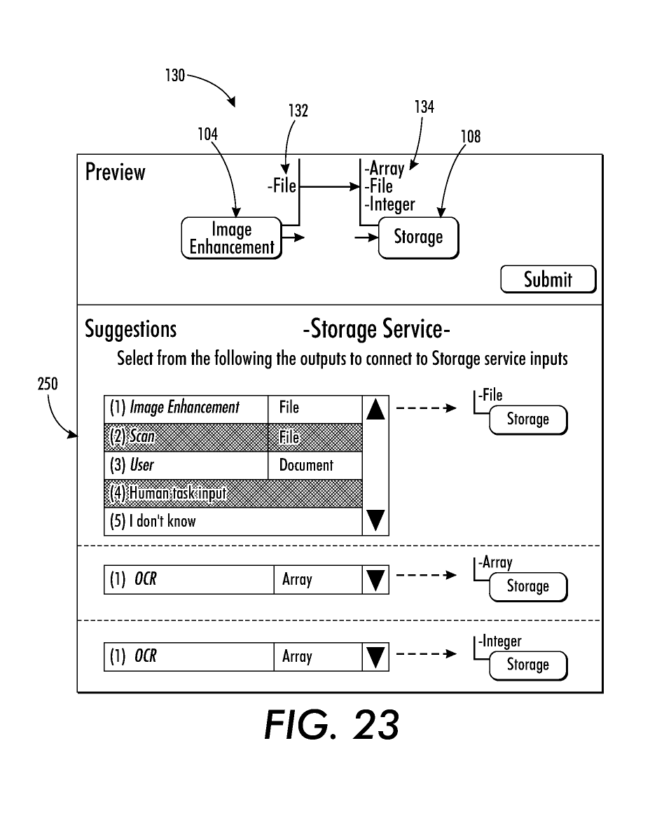

As shown in FIGS. 20-22, for ranking groups 264 and 266, edge services 232, 234 are searched in the service type repository to perform the binding. An edge service Sx has a transformation defined for output of service S1 and input of service S2 of the workflow. The following heuristics are used to rank edge services. As shown in FIG. 20, if service 230 and edge 232 (S1-Sx) and service 236 and edge 234 (Sx-S2) exist in the glue code repository, each service/edge are bound using the respective output/input of S1/S2. As shown in FIG. 21, the remaining inputs of service Sx 238 (other types in the figure) that can be bound with links of types 260 and 262 is maximal. Similarly, as shown in FIG. 22, the remaining inputs of service S2 (236) that can be bound with links of types 260 and 262 with service Sx 240 outputs (other types in the figure) is maximal.

FIG. 23 again illustrates a screenshot 130 of the wizard. As shown in FIG. 23, outputs (of type 260 and 262) are ranked according to the heuristics described above, and given as options to the user by the wizard in a drop down list 250 for each service input, such that the highest ranked choice is selected by default. For instance, in FIG. 23 in drop down list 250, File from Image Enhancement is suggested first to be bound with File from Storage Service.

Other outputs (of type 264 and 266) are shown if the user does not find a suitable choice in the previous list. If a user selects one of these outputs, a list of services that may be used as transformations between the data types will be presented to the user, ranked according to the edge searching heuristics shown above. For instance, in FIG. 5 discussed above, the user selects File from Image Enhancement Service to be bound with Integer from Storage Service which triggers the search for edge services. In this example, Document Numbering Service, Page Counter Service, etc. are found and suggested.

Some outputs may be excluded as suggestions, but will be available to the user on the UI. If the user elects to use one of these outputs, edge services will also be retrieved as for outputs of type 264 and 266 without considering transformation function definitions.

Using the systems and methods herein, a user can input an informal representation of a workflow in softcopy form and configure the bindings of each service through the wizard interface which will provide the most likely suggestions to complete the data flow. Thus, the user will either accept the default suggestion or quickly find a suitable alternative within ranked lists of output and edge service suggestions. If the user is not able to completely specify the data flow with the help of the wizard, the system will keep track of the suitable options so that the missing bindings can be established by complementary mechanisms, e.g., crowdsourcing, human tasks. Therefore, the system provides both flexibility and as much as assistance as the user requires to complete the workflow specification.

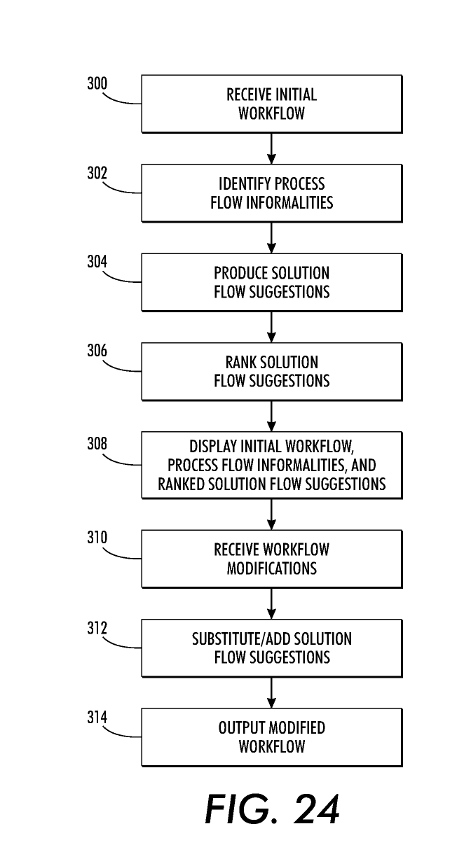

FIG. 24 is flowchart illustrating various exemplary methods herein. In item 300, the methods herein receive an initial workflow into a computerized device from a user. The initial workflow has an overall logical goal to transform at least one input into at least one output.

In item 302, these methods identify process flow informalities within the initial workflow based at least in part on relative positions of flow shapes within the initial workflow, data types of the flow shapes, and use of the flow shapes in previous workflows. For example, the process flow informalities can include missing logical processes, missing connections between logical processes, vague words, syntactic irregularities, and/or illogical process elements, etc.

These methods then produce solution flow suggestions as alternatives to the process flow informalities and/or additions to the initial workflow in item 304. For example, in item 304 these methods can automatically identify inputs and outputs of services within the initial workflow and match the inputs and outputs of items within the initial workflow and items that are not within the initial workflow. In other words, these methods can automatically identify differences between the logic structure of the initial workflow and known valid logic structures (based on the inputs/outputs) and/or automatically identify known process flow elements that are logically equivalent to each of the process flow informalities(based on the inputs/outputs).

These exemplary methods can also rank the solution flow suggestions using the computerized device, as shown in item 306. The ranking gives a higher ranking to solution flow suggestions that are more closely aligned with the overall logical goal (relative to other solution flow suggestions) to produce a ranked order for the solution flow suggestions.

Then, in item 308, these methods can display the initial workflow, the process flow informalities, and the solution flow suggestions in the ranked order to the user on a graphic user interface device (that is operatively connected to the computerized device). In response to the process flow informalities and the solution flow suggestions, these methods can receive workflow modifications from the user through the graphic user interface device, as shown in item 310.

As shown in item 312, these exemplary methods can substitute some of the solution flow suggestions for the process flow informalities in the initial workflow and/or add some of the solution flow suggestions to the initial workflow to produce a modified workflow (again, using the computerized device). This method then outputs the modified workflow from the computerized device in item 314.

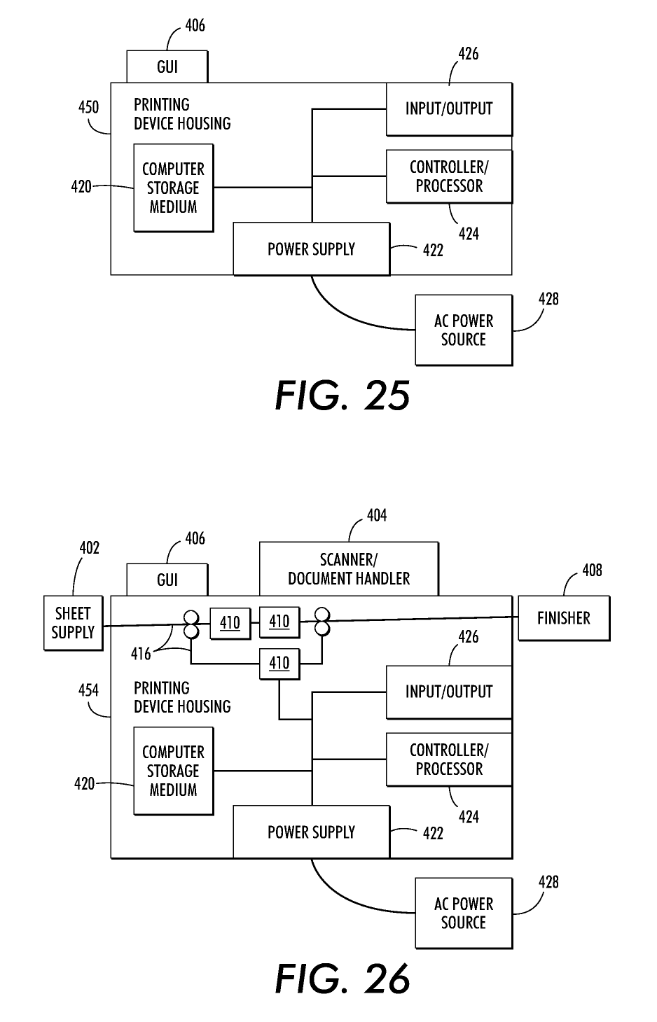

As shown in FIG. 25, an exemplary computerized system 450 embodiment herein can include a computerized device (e.g., a processor 424) receiving the initial workflow. The computerized system 450 includes such a controller/processor 424 and a communications port (input/output) 426 operatively connected to the processor 424 and to a computerized network external to the printing device. Also, the computerized system 450 can include a graphic user interface assembly 406 operatively connected to the processor 424. All such devices operate on the power supplied from the external power source 428 (through a power supply 422).

A non-transitory computer storage medium device 420 (which can be optical, magnetic, capacitor based, etc.) is readable by the processor 424 and stores instructions that the processor 424 executes to allow the computerized system 450 to perform its various functions, such as those described herein.

The processor 424 identifies the process flow informalities within the initial workflow, and the processor 424 produces the solution flow suggestions as alternatives to the process flow informalities. Further, the graphic user interface device 406 displays the initial workflow, the process flow informalities, and the solution flow suggestions. The graphic user interface device 406 then receives workflow modifications in response to the process flow informalities and the solution flow suggestions. The processor 424 can substitute the solution flow suggestions for the process flow informalities in the initial workflow to produce the modified workflow using the processor 424.

As shown in FIG. 26, a document processing device 454 can also be used to process the methods discussed above, and to execute the modified workflow, if the workflow is related to document processing. Thus, FIG. 26 illustrates a computerized printing device 454, which can be used with embodiments herein and can comprise, for example, a printer, copier, multi-function machine, etc. The printing device 454 similarly includes a controller/processor 424, at least one marking device (printing engines) 410 operatively connected to the processor 424, a media path 416 positioned to supply sheets of media from a sheet supply 402 to the marking device(s) 410, and a communications port (input/output) 426 operatively connected to the processor 424 and to a computerized network external to the printing device. After receiving various markings from the printing engine(s), the sheets of media can optionally pass to a finisher 408 which can fold, staple, sort, etc., the various printed sheets.

Also, the printing device 454 can include at least one accessory functional component (such as a scanner/document handler 404, sheet supply 402, finisher 408, etc.) and graphic user interface assembly 406 that operate on the power supplied from the external power source 428 (through the power supply 422).

The input/output device 426 is used for communications to and from the multi-function printing device 454. The processor 424 controls the various actions of the printing device. A non-transitory computer storage medium device 420 (which can be optical, magnetic, capacitor based, etc.) is readable by the processor 424 and stores instructions that the processor 424 executes to allow the multi-function printing device to perform its various functions, such as those described herein.

As would be understood by those ordinarily skilled in the art, the system 450 and printing device 454 shown in FIGS. 25-26 are only examples and the embodiments herein are equally applicable to other types of devices that may include fewer components or more components.

Many computerized devices are discussed above. Computerized devices that include chip-based central processing units (CPU's), input/output devices (including graphic user interfaces (GUI), memories, comparators, processors, etc. are well-known and readily available devices produced by manufacturers such as Dell Computers, Round Rock Tex., USA and Apple Computer Co., Cupertino Calif., USA. Such computerized devices commonly include input/output devices, power supplies, processors, electronic storage memories, wiring, etc., the details of which are omitted herefrom to allow the reader to focus on the salient aspects of the embodiments described herein. Similarly, scanners and other similar peripheral equipment are available from Xerox Corporation, Norwalk, Conn., USA and the details of such devices are not discussed herein for purposes of brevity and reader focus.

The terms printer or printing device as used herein encompasses any apparatus, such as a digital copier, bookmaking machine, facsimile machine, multi-function machine, etc., which performs a print outputting function for any purpose. The details of printers, printing engines, etc., are well-known by those ordinarily skilled in the art and are discussed in, for example, U.S. Pat. No. 6,032,004, the complete disclosure of which is fully incorporated herein by reference. The embodiments herein can encompass embodiments that print in color, monochrome, or handle color or monochrome image data. All foregoing embodiments are specifically applicable to electrostatographic and/or xerographic machines and/or processes. Further, the terms automated or automatically mean that once a process is started (by a machine or a user), one or more machines perform the process without further input from any user.

It will be appreciated that the above-disclosed and other features and functions, or alternatives and additions thereof, may be desirably combined into many other different systems or applications. Various presently unforeseen or unanticipated alternatives and additions, modifications, variations, or improvements therein may be subsequently made by those skilled in the art which are also intended to be encompassed by the following claims. The claims can encompass embodiments in hardware, software, and/or a combination thereof. Unless specifically defined in a specific claim itself, steps or components of the embodiments herein cannot be implied or imported from any above example as limitations to any particular order, number, position, size, shape, angle, color, or material.

What is claimed is:

1. A computer-implemented method comprising:
receiving an initial workflow into a computerized device;
identifying process flow informalities within said initial workflow using said computerized device;
producing solution flow suggestions as alternatives to said process flow informalities using said computerized device;
displaying said initial workflow, said process flow informalities, and said solution flow suggestions on a graphic user interface device operatively connected to said computerized device;
receiving workflow modifications in response to said process flow informalities and said solution flow suggestions through said graphic user interface device;
substituting ones of said solution flow suggestions for said process flow informalities in said initial workflow to produce a modified workflow using said computerized device; and
outputting said modified workflow from said computerized device.

2. The method according to claim 1, said identifying of said process flow informalities being based at least in part on relative positions of flow shapes within said initial workflow, data types of said flow shapes, and use of said flow shapes in previous workflows.

3. The method according to claim 1, said identifying of said process flow informalities comprising automatically identifying inputs and outputs of services within said initial workflow and matching said inputs and outputs.

4. The method according to claim 1, said producing of said solution flow suggestions comprising automatically identifying known process flow elements that are logically equivalent to each of said process flow informalities.

5. The method according to claim 1, said process flow informalities comprising at least one of missing logical processes, missing connections between logical processes, vague words, syntactic irregularities, and illogical process elements.

6. A computer-implemented method comprising:
receiving an initial workflow into a computerized device;
identifying process flow informalities within said initial workflow using said computerized device;
producing solution flow suggestions as alternatives and additions to said process flow informalities using said computerized device;
ranking said solution flow suggestions using said computerized device to produce a ranked order for said solution flow suggestions;
displaying said initial workflow, said process flow informalities, and said solution flow suggestions in said ranked order on a graphic user interface device operatively connected to said computerized device;
receiving workflow modifications in response to said process flow informalities and said solution flow suggestions through said graphic user interface device;
at least one of substituting ones of said solution flow suggestions for said process flow informalities in said initial workflow and adding ones of said solution flow suggestions to said initial workflow to produce a modified workflow using said computerized device; and
outputting said modified workflow from said computerized device.

7. The method according to claim 6, said identifying of said process flow informalities being based at least in part on relative positions of flow shapes within said initial workflow, data types of said flow shapes, and use of said flow shapes in previous workflows.

8. The method according to claim 6, said identifying of said process flow informalities comprising automatically identifying inputs and outputs of services within said initial workflow and matching said inputs and outputs.

9. The method according to claim 6, said producing of said solution flow suggestions comprising automatically identifying known process flow elements that are logically equivalent to each of said process flow informalities.

10. The method according to claim 6, said process flow informalities comprising at least one of missing logical processes, missing connections between logical processes, vague words, syntactic irregularities, and illogical process elements.

11. A computer-implemented method comprising:
receiving an initial document processing workflow into a computerized device from a user, said initial document processing workflow having an overall logical goal to transform at least one input into at least one output;
identifying process flow informalities within said initial document processing workflow using said computerized device;
producing solution flow suggestions as alternatives to said process flow informalities and additions to said initial document processing workflow, using said computerized device;
ranking said solution flow suggestions using said computerized device, said ranking giving ones of said solution flow suggestions that are more closely aligned with said overall logical goal a higher ranking, relative to other ones of said solution flow suggestions to produce a ranked order for said solution flow suggestions;
displaying said initial document processing workflow, said process flow informalities, and said solution flow suggestions in said ranked order to said user on a graphic user interface device operatively connected to said computerized device;
receiving document processing workflow modifications in response to said process flow informalities and said solution flow suggestions from said user through said graphic user interface device;
at least one of substituting ones of said solution flow suggestions for said process flow informalities in said initial document processing workflow and adding ones of said solution flow suggestions to said initial document processing workflow to produce a modified document processing workflow using said computerized device; and
outputting said modified document processing workflow from said computerized device.

12. The method according to claim 11, said identifying of said process flow informalities being based at least in part on relative positions of flow shapes within said initial workflow, data types of said flow shapes, and use of said flow shapes in previous workflows.

13. The method according to claim 11, said identifying of said process flow informalities comprising automatically identifying inputs and outputs of services within said initial workflow and matching said inputs and outputs.

14. The method according to claim 11, said producing of said solution flow suggestions comprising automatically identifying known process flow elements that are logically equivalent to each of said process flow informalities.

15. The method according to claim 11, said process flow informalities comprising at least one of missing logical processes, missing connections between logical processes, vague words, syntactic irregularities, and illogical process elements.

16. A computerized document processing system comprising:
a computerized device receiving an initial document processing workflow, said computerized device identifying process flow informalities within said initial document processing workflow, and said computerized device producing solution flow suggestions as alternatives to said process flow informalities;
a graphic user interface device operatively connected to said computerized device,
said graphic user interface device displaying said initial document processing workflow, said process flow informalities, and said solution flow suggestions,
said graphic user interface device receiving workflow modifications in response to said process flow informalities and said solution flow suggestions, and
said computerized device substituting ones of said solution flow suggestions for said process flow informalities in said initial workflow to produce a modified document processing workflow; and
a document processing device operatively connected to said computerized device, said document processing device executing said modified document processing workflow.

17. The computerized document processing system according to claim 16, said identifying of said process flow informalities being based at least in part on relative positions of flow shapes within said initial workflow, data types of said flow shapes, and use of said flow shapes in previous workflows.

18. The computerized document processing system according to claim 16, said identifying of said process flow informalities comprising said computerized device automatically identifying inputs and outputs of services within said initial workflow and matching said inputs and outputs.

19. The computerized document processing system according to claim 16, said producing of said solution flow suggestions comprising said computerized device automatically identifying known process flow elements that are logically equivalent to each of said process flow informalities.

20. The computerized document processing system according to claim 16, said process flow informalities comprising at least one of missing logical processes, missing connections between logical processes, vague words, syntactic irregularities, and illogical process elements.
